(19) United States
(12) Patent Application Publication
(10) Pub. No.: US 2013/0199840 A1
(43) Pub. Date: Aug. 8, 2013

(54) Printed circuit board (PCB) connecting cable and manufacturing method thereof

(71) Applicant: Dong-Jin Seo, Incheon (KR)

(72) Inventor: Dong-Jin Seo, Incheon (KR)

(21) Appl. No.: 13/877,120

(22) PCT Filed: Nov. 10, 2010
(86) PCT No.: PCT/KR2010/007919

§ 371 Date: Mar. 29, 2013

(30) Foreign Application Priority Data
Oct. 1, 2010 (KR) 10-2010-0096069

(51) Int. Cl. H01R 43/00; H01R 12/50

(52) U.S. Cl. CPC H01R 43/00; H01R 12/50
USPC 174/74 R; 29/825

(57) ABSTRACT

A light emitting diode (LED) connecting cable is provided. The LED connecting cable includes a conductive strip which is formed as a metallic semicircular rod and which includes a plurality of connecting pins or connecting pads to be connected to an externally-provided printed circuit board (PCB) in a blockwise unit, an outer protection casing formed from an insulating material on an upper surface of the conductive strip, and an antishocking material charged in between the conductive strip and the outer protection casing, wherein the PCB includes a fixing support formed therein to fix the outer protection casing.

### TECHNICAL FIELD

The present invention relates to a stripe-type cable which is directly soldered on a printed circuit board (PCB), and more particularly, to a light emitting diode (LED) connecting cable which enables cutting and connecting of PCB and a manufacturing method thereof.

### BACKGROUND ART

Generally, printed circuit board (PCB) cannot be cut once it is manufactured because if the printed pattern on the PCB is cut, the PCB is not available for use. Among recently manufactured PCBs, most PCBs with parallel pattern are connected to power supply lines only.

One of the examples is LED strip lighting which is difficult to connect once it is cut. To solve the above problem, pin is pierced into the PCB to provide a space for cutting and place a connector therein. However, with the above method, users cannot cut the targeted position as precisely as he wishes.

### DISCLOSURE

### [Technical Problem]

The present invention aims to overcome the problems of the prior art and accordingly, it is an object of the present invention to provide a LED connecting cable which is easily cut and re-connected, and with which a user can cut and reconnect a PCB easily regardless of the position, and a manufacturing method thereof.

### [Technical Solution]

To solve the technical problem, a LED connecting cable, with which a PCB can easily be cut and reconnected, includes a conductive strip formed as a metallic semicircular rod and includes a plurality of connecting pins or connecting pads to connect to an externally-provided PCB in a blockwise unit; an outer protection casing formed from an insulating material on the upper surface of the conductive strip; and an antishocking material filled in between the conductive strip and the outer protection casing, in which the PCB includes a fixing support provided therein theto fix the outer protection casing.

The LED connecting cable is formed in a unit of a cuttable block.

The cross section of the LED connecting cable is formed in various curved configurations including semicircle, triangle, quadrangle, or star to prevent bending of the conductive strip during cutting.

In order to solve the technical problem discussed above, a method for forming a LED connecting cable according to an embodiment of the present invention includes the steps of: preparing a conductive strip formed as a metallic semicircular rod having a plurality of connecting pins to connect to an externally-provided PCB in a blockwise unit; preparing an outer protection casing formed from an insulating material on an upper surface of the conductive strip; and charging an antishocking material in between the conductive strip and the outer protection casing, in which the PCB includes a fixing support to fix the outer protection casing.

In the step of preparing the conductive strip, a concaved portion of the conductive strip formed as the metallic semicircular rod faces the externally-provided PCB.

The antishocking material includes a bond component.

### [Advantageous Effects]

With the connecting cable enabling cutting and reconnecting of the PCB and a connecting method thereof according to an embodiment of the present invention, a user is able to cut and reconnect the PCB easily at any position and at any time, and to connect to other block at a corresponding position or other position, while various cross sections are provided according to the characteristics of the product so bending is prevented during cutting.

Accordingly, it is possible to manufacture products appropriate for various fields, thereby preventing waste of resources and providing opportunity to create new products.

### BRIEF DESCRIPTION OF THE DRAWINGS

FIG. 1 is a schematic view illustrating a process of forming a LED connecting cable according to an embodiment of the present invention;

FIG. 2 is a cross-sectional diagram of the LED connecting cable of FIG. 1;

FIG. 3 is a schematic view of the LED connecting cable of FIG. 1 cut into a predetermined block unit; and

FIGS. 4a to 4d are cross-sectional diagrams of FIG. 2 according to various examples of the present invention.

### BEST MODE

The present inventive technical concept will be explained in greater detail below based on the exemplary embodiments which are not to be construed as limiting the present inventive concept. To make the present invention clear, irrelevant parts are deleted in the drawings, and similar reference numbers are named in the whole specification when it comes to similar parts.

To help understand the purpose and advantages of the invention, preferred embodiments of the present invention will be explained below with reference to the attached drawings.

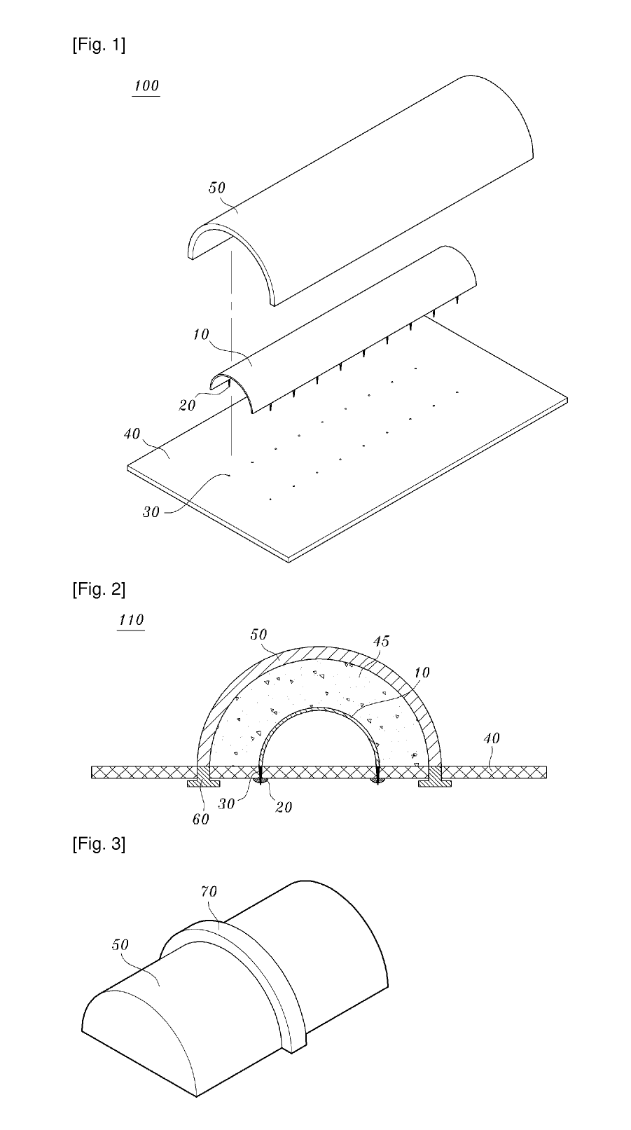

FIG. 1 is a schematic view of a LED connecting cable (100) according to an embodiment of the present invention.

The LED connecting cable (100) includes a conductive strip (10), a printed circuit board (PCB, 40), an antishocking material (not illustrated) and an outer protection casing (50).

The conductive strip (10) is formed as a semicircular rod made from a highly conductive metal and includes a plurality of connecting pins (20) or connecting pads (not illustrated) to connect to an externally-provided PCB (40) which is formed in a blockwise unit.

The conductive strip (10) includes at least two connecting pins (20) to connect to the PCB (40) in a blockwise unit, in which the connecting pins (20) are engaged with a plurality of connecting holes (30) formed on the PCB (40) and secured by external soldering.

The PCB (40) is a LED circuit board which includes a plurality of connecting holes (30) formed therein in a blockwise unit of repeating (+) and (−) terminals in parallel, to connect to a built-in power supply wire.

The PCB (40) may include fixing supports (not illustrated) in the same form as the connecting hole (30) on the PCB to fix the outer protection casing (50). The fixing supports securely fix the outer protection casing (50).

The outer protection casing (50) may be formed from an insulating material such as plastic, to protect the outer form of the conductive strip (10) from the external impact.

The antishocking material (not illustrated) may include bond component which has high thermal diffusivity, and be filled in the space between the conductive strip (10) and the outer protection casing (50).

FIG. 2 is a cross-sectional diagram of the LED connecting cable of FIG. 1.

Referring to FIG. 2, to the externally-provided PCB circuit board (4), the conductive strip (10) is connected. The conductive strip (10) is formed as a semicircular rod with a highly conductive metal and includes a plurality of connecting pins (20) or connecting pads (not illustrated) to connect to the externally-provided PCB (40) in blockwise unit. The connecting pins (20) are engaged with a plurality of connecting holes (30) formed on the PCB (40) and firmly coupled with each other by external soldering.

The PCB (40) is LED circuit board having a plurality of connecting holes (30), and each connecting hole (30) is connected to a built-in power supply wire having (+)and (−) terminals repeating in parallel in a blockwise unit.

The PCB (40) additionally includes a plurality of fixing supports (60) to fix the outer protection casing (50) on the same plane as the connecting holes (30) of the PCB (40).

After that, the outer protection casing (50) is formed on the upper surface of the conductive strip (20) and a predetermined space is formed between upper part of the conductive strip (20) and the outer protection casing (50). The antishocking material (45) is filled in the predetermined space.

The antishocking material (45) may include bond component with high thermal diffusivity and prevent bending of the conductive strip (20) when the LED connecting cable (100) is cut.

FIG. 3 illustrates the LED connecting cable on which the connecting block is mounted.

Referring to FIG. 3, the connecting block (70) is inserted into the surface of the outer protection casing (50) of LED connecting cable to connect the respective cross sections of the cables. Accordingly, users can place LED connecting cable, prepared in the shape and size according to the shape of cutting cable of cable, in any position between two cross sections.

Meanwhile, a rod in the same shape as the cross section of the cable is inserted into the cable before cutting. The rod may be made from a material that allows easy machining, such as, for example, wood.

Bending of cross section of the conductive strip is prevented when the cable is cut by inserting the rod (e.g., wood) which has the same shape as cross section of the cable.

The connecting block (70) is hardly inserted if the cross section is not clean. The cross section is more likely to bend if the shape of cross section is polygon such as star, or triangle. Accordingly, it is important that the same shape of wooden rod is inserted before cutting.

Due to the antishocking material filled in between outer protection casing (50) and conductive strip (10), ( [symbol] ?) may be easily inserted and attached to connect between cross sections of the LED connecting cables by gentle striking on an externally-provided tool such as a hammer.

The connecting block (70) has the features of: i) having the same shape and size as the conductive strip (10); ii) having a stop portion to prevent all the blocks from entering into one conductive strip (10); and iii) being made from a metallic material but having the outer portion plated with conductive component.

in the outer portion of the connecting block (70) is plated with the conductive component because electric charge flows only along the outer portion of the conductor when electricity flows.

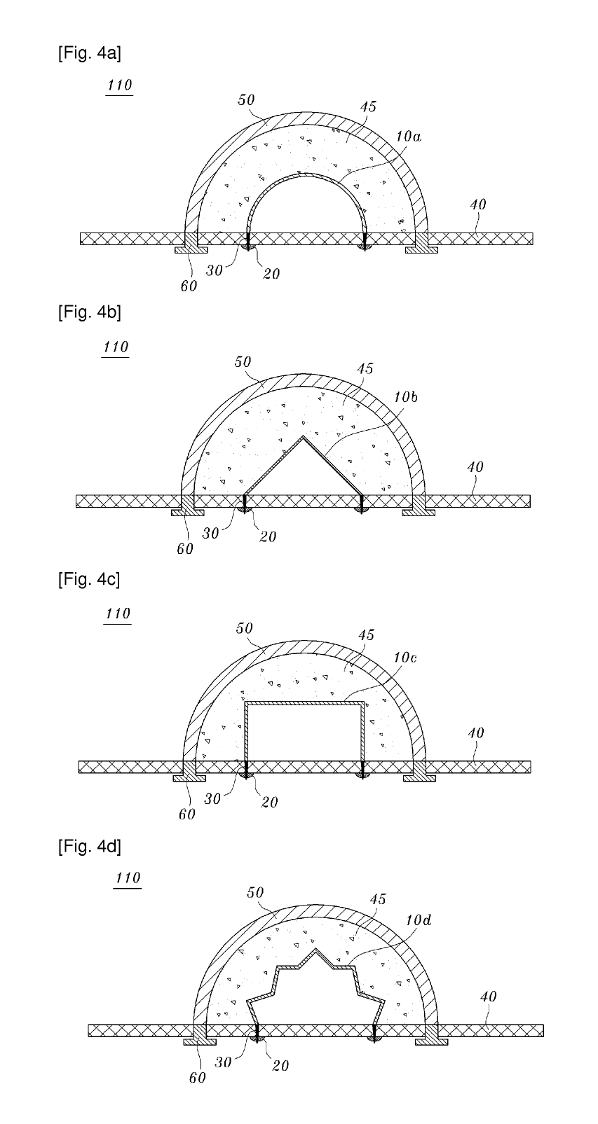

FIGS. 4a to 4d are cross-sectional diagrams of FIG. 2 in a variety of configurations.

As disclosed in FIG. 2 and FIGS. 4a to 4d, the cross section (110) of LED connecting cable is formed in a semicircular configuration.

The conductive strip (10) in the cross section of the LED connecting cable may be formed in a semicircular, triangular, quadrangular or polygonal shape.

The shape of cross section of the LED connecting cable may change according to the angle of cross section, and the cross section of connecting cable may be formed according to the shape of cross section.

A method for forming a LED connecting cable according to an embodiment of the present invention includes the steps of: (S10) preparing a conductive strip formed as a metallic semicircular rod and including a plurality of connecting pins to connect to an externally-provided PCB in a blockwise unit; (S20) preparing an outer protection casing formed on an upper surface of the conductive strip and made from an insulating material; and (S30) charging with an antishocking material in between the conductive strip and the outer protection casing.

In step (S10), a concaved surface of the conductive strip, formed as the semicircular rod, is faced to the externally-provided PCB.

The step (S20) may include the step of fixing the outer protection casing (50) to the PCB (40), and fixing the outer protection casing (50) using a fixing support (not illustrated) which is formed in the same configuration as the connecting holes 30 inside the PCB (40).

Accordingly, the outer protection casing (50) may be made from an insulating material such as plastic, to protect the outer shape of the conductive strip (10) from the external impact.

The step (S30) may include the step of charging a space defined between the conductive strip (10) and the outer protection casing (50) with a bond component with high degree of thermal diffusivity to prevent bending of the conductive strip (20) formed inside, during cutting of the LED connecting cable (100).

Accordingly, the present invention has been made to overcome the problems arising in the prior art as explained above, and therefore, the present invention provides a LED connecting cable with which a user is able to cut and re-connect easily at any position.

Accordingly, the LED connecting cable includes rod-type cable and pins to engage the corresponding cable by soldering to the PCB, in which the rod-type cable and the pins are configured appropriately according to the structure of the PCB cable, for example, in the forms such as semicircular, triangular, pentagonal, hexagonal, or star configurations, thereby enabling a user to select a product according to the angle of cutting and mount the same accordingly.

The cross section of an inserting portion of the connecting block is sized larger than the cross section of the cable, to enable insertion of the cable by gentle striking with an appropriate tool such as a hammer.

According to an embodiment of the present invention, the LED connecting cable and the cable are connected with each other by the connecting block so that the cables are prevented from being separated from each other. Additionally, since the cable includes soldering pins therein, if PCB circuit is designed tin consideration of corresponding pins, it is possible to insert the cable and fix by soldering at the corresponding positions.

Furthermore, bending or twisting of the cross section of the cable is prevented when the PCB is cut with a saw grinder or the like and strong impact is exerted, due to the filter (80) charged in between the outer protection casing (50) and the conductive strip (10).

According to an embodiment of the present invention, the PCB can be cut at any portion and yet connected easily. Due to the connecting pins, which are electrically-conductive, are attached to the PCB (40) by soldering, and the connecting block (70) to connect the cables after cutting, the outer portion of the conductor is additionally protected and the impact to the cross section is minimized.

Furthermore, the present invention solves problems related with cutting and connecting of the LED lighting module, and applicable in a DC power unit of multi-purpose PCB and short-distance communication cable module.

The easy cutting and connecting of the PCB according to the present invention provides many advantages, and the invention is particularly advantageously applicable in the LED lighting market which has rapidly grown recently. Additionally, by providing connecting and coupling manners according to various modified examples, the present invention is applicable to a wide range of fields.

Furthermore, easy cutting and connecting according to the present invention can lift the current limit of design, and therefore, new product design and production is possible.

The present invention is described in the embodiments but not limited thereto and may be readily utilized as a basis for modifying or designing other embodiments for carrying out the same purposes of the present invention.

### DESCRIPTION OF REFERENCE NUMBERS

10: conductive strip
20: connecting pin
30: connecting hole
40: PCB
45: antishocking material
50: outer protection casing
60: fixing support
70: connecting block
100: LED connecting cable
110: cross-sectional diagram of LED connecting cable

1. A light emitting diode (LED) connecting cable, comprising:
a conductive strip which is formed as a metallic semicircular rod and which includes a plurality of connecting pins or connecting pads to be connected to an externally-provided printed circuit board (PCB) in a blockwise unit;
an outer protection casing formed from an insulating material on an upper surface of the conductive strip; and
an antishocking material charged in between the conductive strip and the outer protection casing,
wherein the PCB includes a fixing support formed therein to fix the outer protection casing.

2. The LED connecting cable of claim 1, being formed in a unit of a cuttable block.

3. The LED connecting cable of claim 2, wherein a cross section of the LED connecting cable is formed in one of various curved configurations, including semicircular, triangular, quadrangular or star configurations, to prevent bending of the conductive strip during cutting.

4. A method for forming a light emitting diode (LED) connecting cable, the method comprising the steps of:
preparing a conductive strip which is formed as a metallic semicircular rod and which includes a plurality of connecting pins or connecting pads to be connected to an externally-provided printed circuit board (PCB) in a blockwise unit;
preparing an outer protection casing formed from an insulating material on an upper surface of the conductive strip; and
charging an antishocking material in between the conductive strip and the outer protection casing,
wherein the PCB includes a fixing support to fix the outer protection casing.

5. The method of claim 4, in the step of preparing the conductive strip, a concaved surface of the conductive strip, formed as the semicircular rod, is faced toward the externally-provided PCB.

6. (canceled)
